(19) United States
(12) Patent Application Publication
(10) Pub. No.: US 2013/0295484 A1
(43) Pub. Date: Nov. 7, 2013

(54) MATERIAL FOR SOLID OXIDE FUEL CELL, CATHODE FOR SOLID OXIDE FUEL CELL AND SOLID OXIDE FUEL CELL INCLUDING THE SAME, AND METHOD OF MANUFACTURE THEREOF

(71) Applicant: SAMSUNG ELECTRONICS CO., LTD., Suwon-si, Gyeonggi-do (KR)

(72) Inventors: Soo-yeon SEO, Seoul (KR); Hee-jung PARK, Suwon-si (KR); Kyoung-seok MOON, Hwaseong-si (KR); Chan KWAK, Yongin-si (KR)

(73) Assignee: Samsung Electronics Co., Ltd., Suwon-si (KR)

(21) Appl. No.: 13/864,538

(22) Filed: Apr. 17, 2013

(30) Foreign Application Priority Data
May 2, 2012 (KR) 10-2012-0046432

(51) Int. Cl. H01M 4/90

(52) U.S. Cl. CPC H01M 4/9033
USPC 429/482; 252/519.15; 252/519.12; 252/517

(57) ABSTRACT

A material for a solid oxide fuel cell, the material including: a first metal oxide represented by Formula 1 and having a perovskite crystal structure; a second metal oxide having an electronic conductivity which is greater than an electrical conductivity of the first metal oxide, a thermal expansion coefficient which is less than a thermal expansion coefficient of the first metal oxide, and having a perovskite crystal structure; and a third metal oxide having a fluorite crystal structure:

BaₐSr_{b}CoₓFe_{y}Z_{1-x-y}O_{3-δ}, Formula 1
wherein Z is at least one element selected from an element of Groups 3 to 12 and a lanthanide element, a and b satisfy 0.4≦a≦0.6, 0.4≦b≦0.6, and a+b≦1, x and y satisfy 0.6≦x≦0.9, 0.1≦y≦0.4, and x+y<1, and δ is selected such that the first metal oxide is electrostatically neutral.

### CROSS-REFERENCE TO RELATED APPLICATIONS

This application claims priority to and the benefit of Korean Patent Application No. 10-2012-0046432, filed on May 2, 2012, and all the benefits accruing there from under 35 U.S.C. §119, the content of which is incorporated herein in its entirety by reference.

### BACKGROUND

1. Field

The present disclosure relates to a material for a solid oxide fuel cell, a cathode for a solid oxide fuel and solid oxide fuel cell including the same, and method of manufacture thereof.

2. Description of the Related Art

Solid oxide fuel cells (“SOFC”s), which are a high-efficiency, environmentally friendly power generation technology for directly converting chemical energy of fuel gas to electrical energy, use an ionically-conductive solid oxide electrolyte. SOFCs have many advantages, such as use of low-priced materials relative to other fuel cells, a relatively high permissible level of gas impurities, hybrid power generation capability, high efficiency, and the like. Furthermore, direct use of a hydrocarbon-based fuel without reforming to provide hydrogen may lead to a simplified fuel cell system and additional cost reduction. An SOFC includes an anode where oxidation of a fuel such as hydrogen or a hydrocarbon occurs, a cathode where reduction of oxygen gas to oxygen ions (O²⁻) occurs, and an ion conductive solid oxide electrolyte for conducting the oxygen ions (O²⁻).

Existing SOFCs use high-temperature durable materials such as high-temperature alloys or costly ceramic materials because they operate at a temperature of 800˜1,000° C. Also, existing SOFCs can have a long start-up time, and durability of materials can limit the duration of system operation. Materials durability issues can lead to an overall cost increase, which has been a significant obstacle to commercialization.

For these reasons, a great deal of research has been conducted into lowering the operating temperature of SOFCs to 800° C. or less. However, reducing the operation temperature of an SOFC may lead to an increase in the electrical resistance of a cathode material therein, and the increase in the electrical resistance may be a primary cause of reduced output of the SOFC. Thus to lower the cathode resistance and provide a medium-low temperature SOFC, it would be desirable to provide an improved material for a solid oxide fuel cell.

### SUMMARY

Provided is a material for a solid oxide fuel cell, for reducing cathode resistance.

Provided is a cathode for a solid oxide fuel cell, including the material for a solid oxide fuel cell.

Provided is a solid oxide fuel cell including the cathode for a solid oxide fuel cell.

Additional aspects will be set forth in part in the description which follows and, in part, will be apparent from the description.

According to an aspect, disclosed is a material for a solid oxide fuel cell, the material including a first metal oxide represented by Formula 1 and having a perovskite crystal structure; a second metal oxide having an electronic conductivity which is greater than an electrical conductivity of the first metal oxide, a thermal expansion coefficient which is less than a thermal expansion coefficient of the first metal oxide, and having a perovskite crystal structure; and a third metal oxide having a fluorite crystal structure:

BaₐSr_{b}CoₓFe_{y}Z_{1-x-y}O_{3-δ}, Formula 1

wherein Z is at least one element selected from an element of Groups 3 to 12 and a lanthanide element,

a and b satisfy 0.4≦a≦0.6, 0.4≦b≦0.6, and a+b≦1,

x and y satisfy 0.6≦x≦0.9, 0.1≦y≦0.4, and x+y<1, and

δ is selected such that the first metal oxide electrostatically neutral.

In Formula 1, the element of Group 3 to 12 may be at least one selected from manganese (Mn), zinc (Zn), nickel (Ni), titanium (Ti), niobium (Nb), and copper (Cu).

In Formula 1, the lanthanide element may be at least one selected from holmium (Ho), ytterbium (Yb), erbium (Er), and thulium (Tm).

In Formula 1, x and y may satisfy 0.7≦x+y≦0.95.

The first meal oxide may have an ionic conductivity of about 0.01 to about 0.03 Siemens per centimeter (Scm⁻¹) at a temperature of about 500 to about 900° C.

The second metal oxide may have an electronic conductivity of about 100 to about 1000 Scm⁻¹ and a thermal expansion coefficient of about 11×10⁻⁶ to about 17×10⁻⁶ per Kelvin (K⁻¹) at a temperature of about 500 to about 900° C.

The second metal oxide may be represented by Formula 2:

A′_{1-x′}A″_{x′}QO_{3-γ}, Formula 2

wherein A′ is at least one element selected from lanthanum (La), samarium (Sm), and praseodymium (Pr),
A″ is at least one element selected from strontium (Sr), calcium (Ca), and barium (Ba) and is different from A′,

Q is at least one selected from manganese (Mn), iron (Fe), cobalt (Co), nickel (Ni), copper (Cu), titanium (Ti), niobium (Nb), chromium (Cr), and scandium (Sc),

0≦x′<1, and

γ is selected such that the second metal oxide is electrostatically neutral.

The second metal oxide may be represented by Formula 3:

La_{c}Sr_{d}Q′_{w}Q″_{z}O_{3-γ}, Formula 3

wherein Q′ is at least one selected from cobalt (Co) and chromium (Cr),

Q″ is at least one selected from iron (Fe) and manganese (Mn),

c and d satisfy that 0.5≦c—0.7, 0.3≦d≦0.5, and c+d≦1,

w and z satisfy that 0.1≦w≦0.9, 0.1≦z≦0.9, and w+z≦1, and

γ is selected such that the second metal oxide is electrostatically neutral.

The second metal oxide may be represented by Formula 4:

Pr_{c′}Sr_{d′}Co_{w′}Fe_{z′}O_{3-γ}, Formula 4

wherein c′ and d′ satisfy that 0.4≦c′≦0.8, 0.2≦d′≦0.6, and c′+d′≦1,

w′ and z′ satisfy that 0.2≦w′≦0.8, 0.2≦d′≦0.8, and w′+z′≦1, and

γ is selected such that the second metal oxide is electrostatically neutral.

The second metal oxide may be represented by Formula 5:

LaₑSr_{f}Q″O_{3-γ}, Formula 5

wherein Q″ is at least one selected from iron (Fe) and manganese (Mn),

e and f satisfy that 0.4≦e≦0.8, 0.2≦f≦0.6, and e+f≦1, and

γ is selected such that the second metal oxide is electrostatically neutral.

The second metal oxide may be represented by Formula 6:

Pr_{e′}Sr_{f′}Q″O_{3-γ}, Formula 6

wherein Q″ is at least one selected from Fe and Mn,

e′ and f′ satisfy that 0.4≦e′≦0.8, 0.2≦f′≦0.6, and e′+f′≦1, and

γ is selected such that the second metal oxide is electrostatically neutral.

The second metal oxide may be represented by Formula 7:

Sm₁₋ᵣSrᵣQ″O_{3-γ}, Formula 7

wherein Q″ is at least one selected from Fe, Mn, and Co,

r satisfies 0.1≦r≦0.5, and

γ is selected such that the second metal oxide is electrostatically neutral.

A weight ratio between the first metal oxide and the second metal oxide may be about 90:10 to about 30:70.

The third metal oxide may be a ceria metal oxide including at least one lanthanide element other than cerium.

The third metal oxide may be a ceria metal oxide represented by Formula 8:

Ce_{1-q}M′_{q}O₂, Formula 8

wherein M′ is at least one selected from lanthanum (La), praseodymium (Pr), neodymium (Nd), promethium (Pm), samarium (Sm), europium (Eu), gadolinium (Gd), terbium (Tb), dysprosium (Dy), and an alloy thereof, and 0<q<1.

The third metal oxide may be a ceria metal oxide that includes at least two lanthanide elements other than cerium, and an average ionic diameter of the at least two lanthanide elements other than cerium may be about 0.90 to about 1.06.

The ceria metal oxide may include at least two elements selected from Sm, Pr, Nd, Pm, and an alloy thereof.

The ceria metal oxide may be represented by Formula 9:

Ce_{1-q′-q″}Sm_{q′}M″_{q″}O₃, Formula 9

wherein M″ is at least one selected from Pr, Nd, Pm, and an alloy thereof, and 0<q′≦0.20, 0<q″≦0.20, and 0<q′+q″≦0.3.

In Formula 9 above, q″ may have a value equal to or less than q′/2.

A weight ratio between the sum of the first metal oxide and the second metal oxide to the third metal oxide may be about 99:1 to about 60:40.

According to another aspect, a cathode for a solid oxide fuel cell includes the material.

According to another aspect, a solid oxide fuel cell includes a cathode for a solid oxide fuel cell including the material; an anode disposed to face the cathode; and a solid oxide electrolyte disposed between the cathode and the anode.

The solid oxide fuel electrolyte may include at least one selected from a zirconia solid electrolyte, a ceria solid electrolyte, and a lanthanum gallate solid electrolyte. In more detail, the solid oxide fuel electrolyte may include at least one selected from zirconia materials doped with at least one of yttrium (Y) and scandium (Sc); undoped zirconia materials; ceria materials doped with at least one of gadolinium (Gd), samarium (Sm), lanthanum (La), ytterbium (Yb), and neodymium (Nd); undoped ceria materials; lanthanum gallate materials doped with at least one of strontium (Sr) and magnesium (Mg); and undoped lanthanum gallate materials.

The solid oxide fuel cell may further include an electric current collector disposed on the cathode. For example, the electric current collector may include at least one selected from lanthanum cobalt oxide (LaCoO₃), lanthanum strontium cobalt oxide (“LSC”), lanthanum strontium cobalt iron oxide (“LSCF”), lanthanum strontium manganese oxide (“LSM”), and lanthanum strontium iron oxide (“LSF”).

The solid oxide fuel cell may further include a functional layer that is disposed between the cathode and the solid oxide electrolyte and prevents a reaction therebetween. For example, the functional layer may include at least one selected from gadolinia-doped ceria (“GDC”), samaria-doped ceria (“SDC”), and yttria-doped ceria (“YDC”).

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic cross-sectional view of a structure of an embodiment of a solid oxide fuel cell (SOFC);

FIG. 2A is a graph of proportion (percent, %) versus particle diameter (micrometers, μm) and shows the results of particle size analysis of the BSCFZ powder used in Preparation Example 3;

FIG. 2B is a graph of proportion (percent, %) versus particle diameter (micrometers, μm) and shows the results of particle size analysis of the LSCF powder used in Preparation Example 3;

FIG. 2C is a graph of proportion (percent, %) versus particle diameter (micrometers, μm) and shows the results of particle size analysis of the SNDC powder used in Preparation Example 3;

FIG. 3 is a graph of relative intensity (arbitrary units, a.u.) versus scattering angle (degrees two-theta, 2θ) comparing X-ray diffraction patterns before and after firing a cathode material of Preparation Example 1 at a temperature of 900° C.;

FIGS. 4A through 4C are cross-sectional scanning electron microscope (SEM) images of a half cell of a test cell prepared in Example 1; and

FIG. 5 is a graph of impedance (Z₁, ohm·cm²) versus duration (hours) which shows the results of durability evaluation of Example 1 and Comparative Examples 2, 5, and 6.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. “Or” means “and/or.” Expressions such as “at least one selected from” and “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A material for a solid oxide fuel cell according to an embodiment includes a first metal oxide and a second metal oxide, each of which have a perovskite crystal structure and are different, and a third metal oxide having a fluorite crystal structure.

The material for a solid oxide fuel cell disclosed herein may be suitable for a cathode material for a solid oxide fuel cell. The material for a solid oxide fuel cell may be provided by disposing and heat treating a composition, e.g., a combination such as a mixture, a slurry, and/or a composite, which includes the first metal oxide, the second metal oxide, and the third metal oxide. The term “composite” refers to a material that is prepared from at least two materials having different physical or chemical properties,

wherein the at least two materials are distinguishable from each other in a finished structure on a macroscopic or microscopic scale.

In general, a perovskite-based material has an ABO₃-type structure and is a mixed ionic and electronic conductor (“MIEC”) having both ionic conductivity and electronic conductivity. Such MIECs are a single phase material with relatively high electronic and ionic conductivities. Due to having a relatively high oxygen diffusion coefficient and a relatively high exchange current density, MIECs may provide for reduction of oxygen on an entire electrode surface as well as at a triple phase boundary area, which results in a relatively high electrode activity at a relatively low temperature, and thus may contribute to lowering of the operating temperature of a SOFC. While not wanting to be bound by theory, it is understood that a barium strontium cobalt iron oxide (“BSCF”) perovskite material, e.g., Ba_{0.5}Sr_{0.5}Co_{0.8}Fe_{0.2}O_{3-δ}, inherently contains a relatively high concentration of oxygen vacancies, and thus provides relatively high oxygen mobility. However, the BSCF perovskite material has a relatively high thermal expansion coefficient (“TEC”) of about 19-20×10⁻⁶ Kelvin⁻¹ (K⁻¹) (in air, at 50-900° C.). While not wanting to be bound by theory, it is understood that the high thermal expansion coefficient may cause an interlayer mismatch, due to mismatch between the thermal expansion coefficients of various layers used in a cathode, or may cause a reduction in stability over prolonged operation.

In a material for a solid oxide fuel cell according to an embodiment, a B-site of a BSCF perovskite structure is doped with at least one element selected from an element of Groups 3 to 12 and a lanthanide element. While not wanting to be bound by theory, it is understood that the BSCF perovskite structure comprising the at least one element selected from an element of Groups 3 to 12 and a lanthanide element at a B-site improves, e.g., reduces, the thermal expansion coefficient of the BSCF perovskite material and maintains desirable low-temperature resistance characteristics, i.e., provides a relatively high ionic conductivity at a relatively low temperature, which is an inherent advantage of the BSCF perovskite material. Therefore, since the stability of a cell employing the BSCF perovskite material as a cathode material may be improved by minimizing the interlayer thermal mismatch of the cell, it is possible to increase durability of the cell.

According to an embodiment, the first metal oxide may be represented by Formula 1.

BaₐSr_{b}CoₓFe_{y}Z_{1-x-y}O_{3-δ} Formula 1

In Equation 1, Z is at least one element selected from an element of Groups 3 to 12 and a lanthanide element,

a and b satisfy that 0.4≦a≦0.6, 0.4≦b≦0.6, and a+b≦1,

x and y satisfy that 0.6≦x≦0.9, 0.1≦y≦0.4, and x+y<1, and

δ is selected such that the first metal oxide is electrostatically neutral.

δ represents a vacancy of oxygen, and is selected such that the material for a solid oxide fuel cell represented by Formula 1 above is electrostatically neutral. For example, δ may have a value in a range of about 0.1 to about 0.4, specifically about 0.2 to about 0.3.

According to an embodiment, a and b satisfy 0.9≦a+b≦1, specifically 0.92≦a+b≦0.98.

According to an embodiment, x and y satisfy 0.7≦x+y≦0.95, specifically 0.75≦x+y≦0.90.

The first metal oxide represented by Formula 1 above may have, for example, a composition of Formulas 1A or 1B:

Ba_{0.5}Sr_{0.5}CoₓFe_{y}Z_{1-x-y}O_{3-δ} Formula 1A

In Formula 1A, Z is at least one element selected from an element of Groups 3 to 12 and a lanthanide element,

x and y satisfy 0.75≦x≦0.85 and 0.1≦y≦0.15, respectively, and

δ is selected such that the compound represented by Formula 1A above is electrostatically neutral.

Ba_{0.5}Sr_{0.5}CO_{0.8}Fe_{0.1}Z_{0.1}O_{3-δ} Formula 1B

In Formula 1B above, Z is at least one element selected from an element of Groups 3 to 12 and a lanthanide element, and

δ is selected such that the compound represented by Formula 1B above is electrostatically neutral.

Examples of the element of Groups 3 to 12 may include, but are not limited to, at least one element selected from manganese (Mn), zinc (Zn), nickel (Ni), titanium (Ti), niobium (Nb), and copper (Cu), and the like.

In the first metal oxides of Formulas 1, 1A, and 1B, the lanthanide element, with which a B-site of the perovskite crystal structure may be doped, is an element of atomic numbers 57 to 70. Examples of the lanthanide element may include, but are not limited to, at least one element selected from holmium (Ho), ytterbium (Yb), erbium (Er), and thulium (Tm), and the like.

The first metal oxide having the above composition has a relatively low low-temperature resistance, i.e., a relatively high ionic conductivity at relatively low temperatures, and for example, may have an ionic conductivity of at least about 0.01 Scm⁻¹, specifically about 0.01 to about 0.3 Scm⁻¹, more specifically about 0.01 to about 0.03 Scm⁻¹ at a temperature of about 500 to about 900° C.

The material for a solid oxide fuel cell may comprise the first metal oxide having a perovskite crystal structure, and include the second metal oxide, which is different from the first metal oxide and has a higher electronic conductivity and a lower thermal expansion coefficient than the first metal oxide.

Since the first metal oxide has a relatively high ionic conductivity but has a relatively low electronic conductivity (e.g., about 10 to about 100 Scm⁻¹) and a relatively high thermal expansion coefficient (e.g., about 16×10⁻⁶ to about 21×10⁻⁶K⁻¹), and because a cubic to hexagonal phase transition may occur in the first metal oxide at a temperature of about 850 to about 900° C., when a solid oxide fuel cell including only the first metal oxide operates for a long period of time, durability of the solid oxide fuel cell may be insufficient. The material for a solid oxide fuel cell also includes the second metal oxide, which is different from the first metal oxide and also has a perovskite crystal structure, and has a higher electronic conductivity and a lower thermal expansion coefficient than the first metal oxide. While not wanting to be bound by theory, it is understood that the second metal oxide compensates for the electronic conductivity of the first metal oxide and reduces the thermal expansion coefficient of the resulting material to provide improved durability. For example, the second metal oxide may have an electronic conductivity of about 100 to about 1000 Scm⁻¹, specifically about 200 to about 900 Scm⁻¹, more specifically about 300 to about 800 Scm⁻¹, and a thermal expansion coefficient of about 11×10⁻⁶ to about 17×10⁻⁶ K⁻¹, specifically 12×10⁻⁶ to about 16×10⁻⁶ K⁻¹, more specifically 13×10⁻⁶ to about 15×10⁻⁶ K⁻¹ at a temperature of about 500 to about 900° C.

According to an embodiment, the second metal oxide may be represented by Formula 2.

A′_{1-x′}A″_{x′}QO_{3-γ} Formula 2

In Formula 2 above, A′ is at least one element selected from lanthanum (La), samarium (Sm), and praseodymium (Pr),

A″ is different from A′, and is at least one element selected from strontium (Sr), calcium (Ca), and barium (Ba),

B′ is at least one element selected from manganese (Mn), iron (Fe), cobalt (Co), nickel (Ni), copper (Cu), titanium (Ti), niobium (Nb), chromium (Cr), and scandium (Sc),

0≦x′<1, and

γ is selected such that the second metal oxide is electrostatically neutral.

Examples of the second metal oxide may include, but are not limited to, at least one selected from lanthanum strontium cobalt ferrite (“LSCF”), lanthanum strontium manganese chromite (“LSCM”), praseodymium strontium cobalt ferrite (“PSCF”), praseodymium strontium manganese chromite (“PSCM”), lanthanum strontium ferrite (“LSF”), lanthanum strontium manganite (“LSM”), lanthanum strontium cobaltite (“LSC”), samarium strontium cobaltite (“SSC”), and samarium strontium manganite (“SSM”), and the like.

According to an embodiment, the second metal oxide may be represented by Formula 3.

La_{c}Sr_{d}Q′_{w}Q″_{z}O_{3-γ} Formula 3

In Formula 3, Q′ is at least one selected from cobalt (Co) and chromium (Cr), and Q″ is at least one selected from iron (Fe) and manganese (Mn),

c and d satisfy 0.5≦c≦0.7, 0.3≦d≦0.5, and c+d≦1,

w and z satisfy 0.1≦w≦0.9, 0.1≦z≦0.9, and w+z≦1, and

γ is selected such that the second metal oxide is electrostatically neutral.

According to another embodiment, the second metal oxide may be represented by Formula 4.

Pr_{c′}Sr_{d′}Co_{w′}Fe_{z′}O_{3-γ} Formula 4

In Formula 4 above, c′ and d′ satisfy that 0.4≦c′≦0.8, 0.2≦d′≦0.6, and c′+d′≦1,

w′ and z′ satisfy 0.2≦w′≦0.8, 0.2≦d′≦0.8, and w′+z′≦1, and

γ is selected such that the second metal oxide is electrostatically neutral.

According to another embodiment, the second metal oxide may be represented by Formula 5.

LaₑSr_{f}Q″O_{3-γ} Formula 5

In Formula 5 above, Q″ is at least one selected from iron (Fe), manganese (Mn), and cobalt (Co),

e and f satisfy 0.4≦e≦0.8 and 0.2≦f≦0.6, and e+f≦1, and

γ is selected such that the second metal oxide is electrostatically neutral.

According to an embodiment, the second metal oxide may be represented by Formula 6.

Pr_{e′}Sr_{f′}Q″O_{3-γ} Formula 6

In Formula 6 above, Q″ is at least one selected from Fe, Mn, and Co,

e′ and f′ satisfy 0.4≦e′≦0.8, 0.2≦f′≦0.6, and e′+f′≦1, and

γ is selected such that the second metal oxide is electrostatically neutral.

According to an embodiment, the second metal oxide may be represented by Formula 7.

Sm₁₋ᵣSrᵣQ″_{p′}O_{3-γ} Formula 7

In Formula 7 above, Q″ is at least one selected from Fe, Mn, and Co,

r satisfies 0.1≦r≦0.5, and

γ is selected such that the second metal oxide is electrostatically neutral.

The amounts of the first metal oxide and the second metal oxide of the material for a solid oxide fuel cell may be determined in consideration of a suitable combination of ionic conductivity, electronic conductivity, and cathode resistance, and the like. For example, a weight ratio between the first metal oxide and the second metal oxide may be about 90:10 to about 30:70, specifically about 85:15 to about 35:65, more specifically about 80:20 to about 40:60. In an embodiment, the first metal oxide and the second metal oxide are each independently contained in an amount of about 10 to about 90 weight percent (wt %), specifically about 20 to about 80 wt %, more specifically about 30 to about 70 wt %, based on a total weight of the material for a solid oxide fuel cell.

The material for a solid oxide fuel cell further includes the third metal oxide having a fluorite crystal structure, in addition to the first metal oxide and the second metal oxide, each of which have a perovskite crystal structure. According to an embodiment, the third metal oxide may be a ceria-based metal oxide comprising, e.g., doped with, at least one lanthanide element other than cerium.

The third metal oxide having a fluorite crystal structure has a relatively high ionic conductivity, further reducing a cathode resistance of the material for a solid oxide fuel cell. The third metal oxide may have a melting point (e.g., CeO₂:>2000° C.) which is higher than a melting point of the first metal oxide (e.g., BSCF, which has a melting point of about 1180° C.). Also, when the third metal oxide and the second metal oxide (e.g., LSCF, which has a melting point of about 1890° C.) are combined with each other, a thermal stability of the resulting material may be increased due to the influence of the second metal oxide and the third metal oxide. Further, when the material is included in a cathode material, an interlayer adhesiveness of the cathode material with a functional layer may be increased when the third metal oxide is present. While not wanting to be bound by theory, it is understood that the third metal oxide improves the durability of a solid oxide fuel cell comprising the third metal oxide.

According to an embodiment, the third metal oxide may be a ceria-based metal oxide represented by Formula 8.

Ce_{1-q}M′_{q}O₂ Formula 8

In Formula 8, M′ is at least one selected from lanthanum (La), praseodymium (Pr), neodymium (Nd), promethium (Pm), samarium (Sm), europium (Eu), gadolinium (Gd), terbium (Tb), dysprosium (Dy), and an alloy thereof, and 0<q<1.

According to an embodiment, the third metal oxide represented by Formula 8 above may comprise, e.g., be doped with, at least two lanthanide elements other than cerium. In an embodiment, an average ionic diameter of the at least two lanthanide elements other than cerium may be about 0.90 to about 1.06. In more detail, the average ion diameter may be about 0.96 to about 0.98. When the average ion diameter is within this range, an ionic conductivity of the material for a solid oxide fuel cell may be further increased. For example, an element M′ doped into the third metal oxide may be at least two selected from Sm, Pr, Nd, Pm, and an alloy of thereof from among the lanthanide elements. In more detail, M′ may include Sm as a dopant and may further include at least one additional dopant selected from Pr, Nd, Pm, and an alloy thereof.

According to an embodiment, the ceria-based metal oxide may be represented by Formula 9.

Ce_{1-q′-q″}Sm_{q′}M″_{q″}O₃ Formula 9

In Formula 9 above, M″ is at least one selected from Pr, Nd, Pm, and an alloy thereof, and

0<q′≦0.20, 0<q″≦0.20, and 0<(q′+q″)≦0.3.

According to an embodiment, in Formula 9 above, q″ may be equal to or less than q′/2.

According to an embodiment, a weight ratio between the sum of the first metal oxide and the second metal oxide to the third metal oxide may be about 99:1 to about 60:40. For example, the weight ratio between the sum of the first metal oxide and the second metal oxide to the third metal oxide may be about 90:10 to about 65:35, in particular, about 80:20 to about 70:30. Within this range, interlayer adhesion may be increased and resistance reduced. In an embodiment, the sum of the content of the first and second metal oxides may be about 60 wt % to about 99 wt %, specifically about 65 wt % to about 95 wt %, and a content of the third metal oxide may be about 40 wt % to about 1 wt %, specifically about 30 wt % to about 5 wt %, each based on a total weight of the material for a solid oxide fuel cell. In another embodiment, the first metal oxide and the second metal oxide, and the third metal oxide are each independently contained in an amount of about 1 to about 99 wt %, specifically about 2 to about 90 wt %, more specifically about 4 to about 90 wt %, based on a total weight of the material for a solid oxide fuel cell. Also, in an embodiment, the third metal oxide is contained in an amount of about 1 to about 99 wt %, specifically about 2 to about 95 wt %, more specifically about 4 to about 90 wt %, based on a total weight of the material for a solid oxide fuel cell.

The particle size of the first metal oxide, the second metal oxide, and the third metal oxide are not particularly limited. For example, the first metal oxide, the second metal oxide, and the third metal may each independently have a mean diameter of about 5 micrometers (μm) or less, for example, about 3 μm or less, in particular, about 1 μm or less, or a particle size of about 0.01 to about 5 μm, specifically about 0.05 to about 3 μm. According to an embodiment, the first metal oxide and the second metal oxide may each have a mean particle diameter of about 0.1 to about 3 μm. Within this range, the ionic conductivity of the material for a solid oxide fuel cell may be suitable and the thermal stability may be increased due to the presence of a material with a relatively high melting point. In addition, the third metal oxide may have a mean diameter of about 0.03 to about 1 μm, specifically about 0.05 to about 0.5 μm. Within this range, an active surface, e.g., an electrochemically active surface, of a cathode comprising the third metal oxide may be increased and crystallite growth may be effectively or substantially prevented due to a difference in an average particle diameter, thereby improving durability of the third metal oxide.

According to another embodiment, there is provided a cathode for a solid oxide fuel cell including the material for a solid oxide fuel cell.

The cathode for a solid oxide fuel cell may be prepared, for example, by preparing a composition including the first metal oxide, the second metal oxide, and the third metal oxide, disposing, e.g., coating, the composition on a substrate to provide a coating, and heat-treating the coating to manufacture the material for a solid oxide fuel cell.

In detail, the cathode for a solid oxide fuel cell may be prepared by mechanically mixing the first metal oxide, the second metal oxide, and the third metal oxide to provide a mixture by, for example, ball milling the first metal oxide and the second metal oxide having a perovskite crystal structure, and the third metal oxide having a fluorite crystal structure, combining the mixture with a solvent to prepare a composition, e.g., a slurry, disposing, e.g., coating, the composition on a substrate to form a coating, and then heat-treating the coating to prepare the material for a solid oxide fuel cell.

The solvent is not specifically limited and may comprise any suitable solvent which can dissolve and/or suspend the first, second, and third metal oxides. The solvent may comprise at least one selected from an alcohol (e.g., methanol, ethanol, butanol, ethylene glycol, glycerol, propylene glycol, polyethylene glycol); water; liquid carbon dioxide; an aldehyde (e.g., acetaldehyde, propionaldehyde, a formamide (e.g., N,N-dimethylformamide); a ketone (e.g., acetone, methyl ethyl ketone, β-bromoethyl isopropyl ketone); acetonitrile; a sulfoxide (e.g., dimethylsulfoxide, diphenylsulfoxide, ethyl phenyl sulfoxide); a sulfone (e.g., diethyl sulfone, phenyl 7-quinolylsulfone); a thiophene (e.g., thiophene 1-oxide); an acetate (e.g., ethylene glycol diacetate, n-hexyl acetate, 2-ethylhexyl acetate); and an amide (e.g., propanamide, benzamide).

The substrate may be a solid oxide electrolyte comprising at least one selected from among a zirconia-based solid electrolyte, a ceria-based solid electrolyte, and a lanthanum gallate-based solid electrolyte. Examples of the substrate include a solid oxide electrolyte including at least one selected from a zirconia-based material doped with at least one selected from yttrium (Y) and scandium (Sc); an undoped zirconia-based material; a ceria-based material doped with at least one selected from gadolinium (Gd), samarium (Sm), lanthanum (La), ytterbium (Yb), and neodymium (Nd); an undoped ceria-based material; a lanthanum gallate-based material doped with at least one selected from strontium (Sr) and magnesium (Mg); and an undoped lanthanum gallate-based material.

The slurry may be disposed directly on the solid oxide electrolyte using a suitable coating method, such as screen printing, deep coating, roller coating, brushing, spraying, reverse roll coating, gravure coating die coating, physical vapor deposition, and thermal spray coating, and the like. Also, an additional functional layer, such as an anti-reaction layer, may optionally be disposed between the electrolyte and an electrode, e.g., the cathode, to effectively prevent a reaction therebetween.

The substrate coated with the slurry may be thermally treated to form a cathode layer. The thermal treatment may be performed at a temperature of about 700 to about 1,000° C. In an embodiment, the thermal treatment may be performed at a temperature of about 800 to about 900° C. When the thermal treatment temperature is within these ranges, the cathode layer may be manufactured to provide a reduced polarization resistance without unsuitable changes in electrical characteristics and/or microstructure of the first metal oxide, the second metal oxide, and the third metal oxide. Given the operating temperature of a middle- or low-temperature SOFC of 800° C. or less, the cathode manufactured using a thermal treatment temperature of about 700 to about 1,000° C. may be able to stably function as a mixed conductor during operation of an SOFC. According to an embodiment, the thermal treatment may be performed at a temperature which is lower than a commercially practiced thermal treatment temperature of perovskite-based cathode materials. While not wanting to be bound by theory, it is understood that the reduced thermal treatment temperature reduces or effectively avoids reaction between the cathode and the electrolyte, thus preventing formation of a non-conductive phase.

In an embodiment, a second cathode layer including a second cathode material, which may be a cathode material commonly used in the art, and/or an electric current collector may be further formed on the cathode for a fuel cell manufactured as described above.

According to another embodiment, there is provided an SOFC including a cathode including the cathode material for a solid oxide fuel cell, an anode disposed opposite to the cathode, and a solid electrolyte disposed between the cathode and the anode.

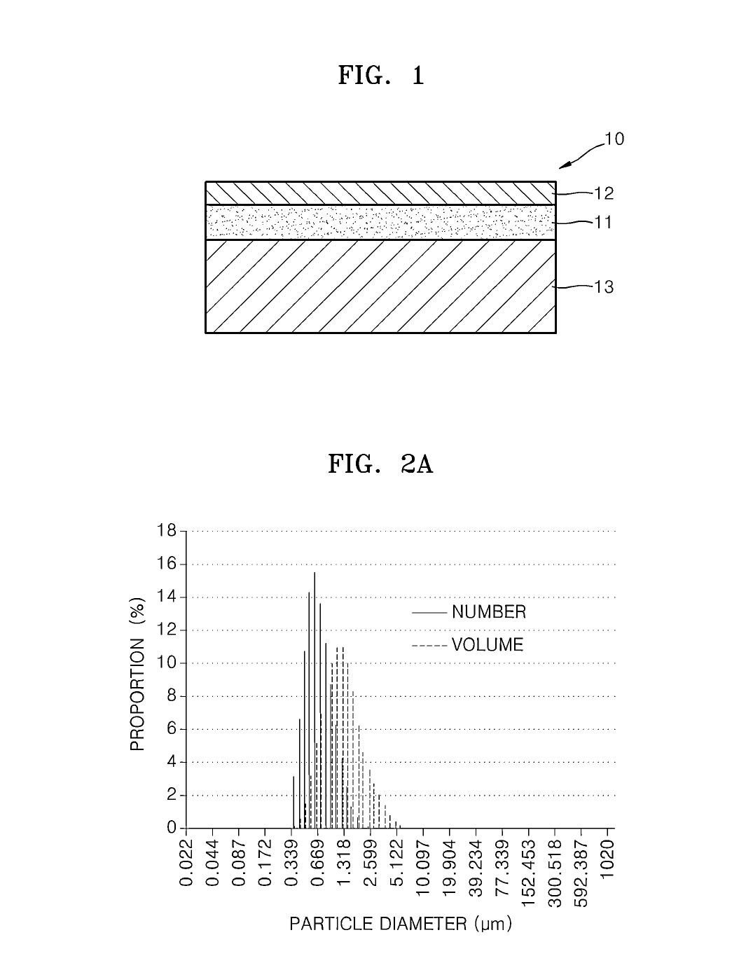

FIG. 1 is a schematic cross-sectional view of a structure of an SOFC 10 according to an embodiment. Referring to FIG. 1, the SOFC 10 includes a cathode 12 and an anode 13 disposed on opposite sides of a solid oxide electrolyte 11.

The solid oxide electrolyte 11 is desirably dense enough to prevent mixing of air and a fuel and to have a relatively high oxygen ion conductivity and a relatively low electron conductivity. Since there is a large difference in oxygen partial pressure with respect to opposite sides of the solid oxide electrolyte 11, on which the cathode 12 and the anode 13 are disposed, the solid oxide electrolyte 11 desirably is able to maintain suitable physical properties over a wide range of oxygen partial pressures.

A material of the solid oxide electrolyte 11 is not specifically limited and may be any suitable solid oxide electrolyte commonly used in the art. For example, the solid oxide electrolyte 11 may include at least one selected from a zirconia-based solid electrolyte, a ceria-based solid electrolyte, and a lanthanum gallate-based solid electrolyte. For example, the solid oxide electrolyte 11 may include at least one selected from a zirconia-based material doped with at least one selected from yttrium (Y) and scandium (Sc); an undoped zirconia-based material; a ceria-based material doped with at least one selected from gadolinium (Gd), samarium (Sm), lanthanum (La), ytterbium (Yb), and neodymium (Nd); an undoped ceria-based material; a lanthanum gallate-based material doped with at least one selected from strontium (Sr) and magnesium (Mg); and an undoped lanthanum gallate-based material. In another embodiment, the solid oxide electrolyte 11 may comprise at least one material selected from a stabilized zirconia-based material such as yttrium-stabilized zirconia (“YSZ”) and a scandium-stabilized zirconia (“SSZ”); a rare earth element-added ceria-based material such as samarium-doped ceria (“SDC”) and gadolinium-doped ceria (“GDC”); and a (La, Sr)(Ga, Mg)O₃-based (“LSGM”) material.

The solid oxide electrolyte 11 may have a thickness of about 10 nm to about 100 μm, and in an embodiment, may have a thickness of about 100 nm to about 50 μm.

The anode (i.e., fuel electrode) 13 is involved in electrochemical oxidation of a fuel and transfer of charges. Therefore, an anode catalyst is desirably chemically compatible with the electrolyte material and has a thermal expansion coefficient similar to that of the electrolyte material. The anode 13 may include a cermet comprising the material of the solid oxide electrolyte 11 and a nickel oxide. For example, when the solid oxide electrolyte 11 comprises YSZ, a Ni/YSZ ceramic-metallic composite may be used for the anode 13. In addition, a Ru/YSZ cermet, or a pure metal such as at least one selected from Ni, Co, Ru, and Pt, and the like, may be used as a material for the anode 13, but the present disclosure is not limited thereto. The anode 13 may further include activated carbon if desired. The anode 13 may be sufficiently porous to facilitate diffusion of a fuel gas therein.

The anode 13 may have a thickness of about 1 μm to about 1,000 μm, and in an embodiment, may have a thickness of about 5 μm to about 100 μm.

The cathode (i.e., air electrode) 12 may reduce oxygen gas into oxygen ions and may allow a continuous flow of air to maintain a constant partial oxygen pressure. The cathode 12 may comprise the material for a solid oxide fuel cell described above including the first metal oxide and the second metal oxide having a perovskite structure and the third metal oxide having a fluorite structure. Since the material for a solid oxide fuel cell has already been described above, a detailed description thereof will not be repeated here.

The cathode 12 may have a thickness of about 1 μm to about 100 μm, and in some embodiments, may have a thickness of about 5 μm to about 50 μm.

The cathode 12 may be sufficiently porous to facilitate diffusion of oxygen gas. Thermally treated at relatively middle or low temperature during its formation, the cathode 12 is protected from reacting with the solid oxide electrolyte 11 to prevent or suppress formation of a non-conductive layer between the cathode 12 and the solid oxide electrolyte 11. In an embodiment, a functional layer may be further included between the cathode 12 and the solid oxide electrolyte 11 if desired, to more effectively prevent a reaction between the two. The functional layer may include, for example, at least one selected from gadolinia-doped ceria (GDC), samaria-doped ceria (SDC), and yttria-doped ceria (YDC). The functional layer may have a thickness of about 1 μm to about 50 μm, and in an embodiment, may have a thickness of about 2 μm to about 10 μm.

In an embodiment, the SOFC 10 may further include an electric current collector layer containing an electron conductor on at least one side of the cathode 12, for example, on an outer side of the cathode 12. The electric current collector layer may serve as a current collector of the cathode structure.

For example, the electric current collector layer may include at least one selected from lanthanum cobalt oxide (e.g., LaCoO₃), lanthanum strontium cobalt oxide (“LSC”), lanthanum strontium cobalt iron oxide (“LSCF”), lanthanum strontium manganese oxide (“LSM”), and lanthanum strontium iron oxide (“LSF”). The electric current collector layer may be formed using any of the materials described above alone or in a combination of at least two thereof. In an embodiment, a single-layered structure or a stacked structure of at least two layers may be formed using these materials.

The SOFC may be manufactured using any suitable process disclosed in literature, the details of which may be determined by one of skill in the art without undue experimentation, and thus a detailed description thereof will not be repeated herein. The SOFC may be applied to any of a variety of structures, for example, a tubular stack, a flat tubular stack, or a planar stack structure.

Hereinafter, an embodiment of the present disclosure will be described in further detail with reference to the following examples. These examples shall not limit the purpose and/or scope of the disclosed embodiment.

### Preparation Example 1

### Preparation of Material for Solid Oxide Fuel Cell (1)

Ba_{0.5}Sr_{0.5}Co_{0.8}Fe_{0.1}Zn_{0.1}O_{3-δ}powder as a first metal oxide of a perovskite-type was synthesized by using a Urea-polyvinyl alcohol (“PVA”) method. In detail, Ba(NO₃)₂, Sr(NO₃)₂, Co(NO₃)₂, Fe(NO₃)₃, Zn(NO₃)₂, and urea were quantified at a molar ratio of 0.5:0.5:0.8:0.1:0.1:3.5. Then, polyvinyl alcohol (“PVA”) was quantified to have the same mass as that of the urea. Then, 1063.1 grams (g) of the quantified materials were added to a 50 liter (L) reactor for liquid phase materials equipped with an agitator. Then, 10 L of deionized water was added to the reactor. Then, the materials contained in the reactor were heated to 200° C. while being stirred, and at this temperature, the materials were left for 3 hours. As a result, a gelled product was obtained. Subsequently, the gelled product was placed in an aluminum crucible and then dried in an oven at a temperature of 100° C. for 24 hours. Then, the dried product was transferred to a calcining furnace and sintered at a temperature of 1000° C. for 5 hours, and then the sintered product was pulverized using a planetary ball mill at a speed of 2000 revolutions per minute (“RPM”) for 24 hours. The pulverized product was dried in an oven to obtain a target powder, Ba_{0.5}Sr_{0.5}Co_{0.8}Fe_{0.1}Zn_{0.1}O_{3-δ} (wherein δ is a value such that the metal oxide represented by this formula is electrostatically neutral, and hereinafter, referred to as ‘BSCFZ’ with regard to the Examples).

The BSCFZ prepared above, La_{0.8}Sr_{0.4}Co_{0.2}Fe_{0.8}O₃ (available from FCM, USA, and hereinafter, referred to as ‘LSCF’), and 10 mole percent (mol %) of gadolinium-doped ceria (“GDC”) (FCM, USA, Ce_{0.9}Gd_{0.1}O₂, and hereinafter, referred to as ‘GDC’) were mixed in a weight ratio of 3.5:3.5:3 via ball milling using zirconia balls in ethanol media. Then, the ball milled product was mixed and dried in an oven to obtain a material for a solid oxide fuel cell.

### Preparation Example 2

### Preparation of Material for Solid Oxide Fuel Cell (2)

A material for a solid oxide fuel cell was prepared in the same manner as in Preparation Example 1, except that BSCFZ, LSCF, and GDC, which were prepared in Preparation Example 1, were mixed in a weight ratio of 4:4:2.

### Preparation Example 3

### Preparation of Material for Solid Oxide Fuel Cell (3)

In Preparation Example 3, ceria doped with Sm and Nd (Ce_{0.8}Sm_{0.15}Nd_{0.05}O₂, and hereinafter, referred to as ‘SNDC’) was synthesized and used as a ceria-based metal oxide instead of GDC. In order to synthesize SNDC, 19.920 g of Ce(NO₃)₃.6H₂O, 3.823 g of Sm(NO₃)₃.6H₂O, 1.257 g of Nd(NO₃)₃.6H₂O, and 6.816 g of urea were put in 100 milliliter (mL) of distilled water, and were stirred by using a bar magnet until completely dissolved. The solution was heated by using a hot plate at a temperature of 150° C. for 12 hours to obtain a powdered product. The powdered product was heat-treated at a temperature of 800° C. for 2 hours to obtain Ce_{0.80}Sm_{0.15}Nd_{0.05}O₂ powder having a fluorite structure.

A material for a solid oxide fuel cell was prepared in the same manner as in Preparation Example 1, except that the prepared SNDC was used instead of GDC.

### Evaluation Example 1

### Average Particle Diameter Analysis of the Material for a Solid Oxide Fuel Cell

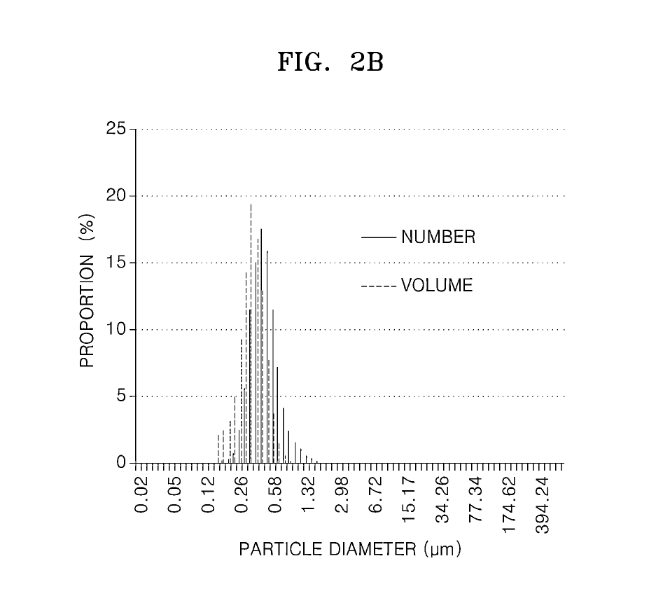

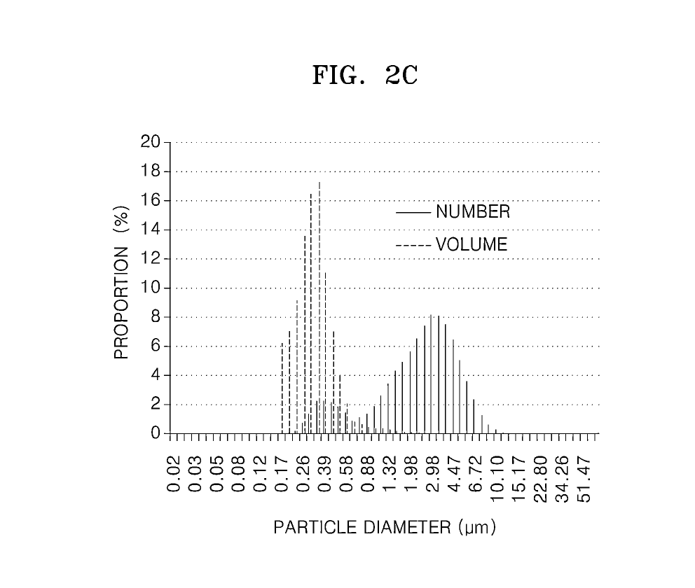

With regard to BSCFZ, LSCF, and SNDC used in Preparation Example 3, average particle sizes were measured using a particle size analyzer (Horiba LA-920 from Horiba Semiconductor), and results thereof are shown in FIGS. 2A through 2C and Table 1.

TABLE 1

| | BSCFZ | LSCF | SNDC |
|---|---|---|---|
| Median Size | 0.581 μm | 0.3253 μm | 0.289 μm |

A number average particle size of BSCFZ was about 0.58 μm without regarding coagulation. A commercially available LSCF has an average particle size of about 0.33 μm, which is smaller than that of the BSCFZ. SNDC was prepared in a solid state, had the smallest particle size distribution having a median size of about 0.29 μm, and was in the form of a powder.

### Evaluation Example 2

### X-ray Diffraction Analysis of the Material for a Solid Oxide Fuel Cell

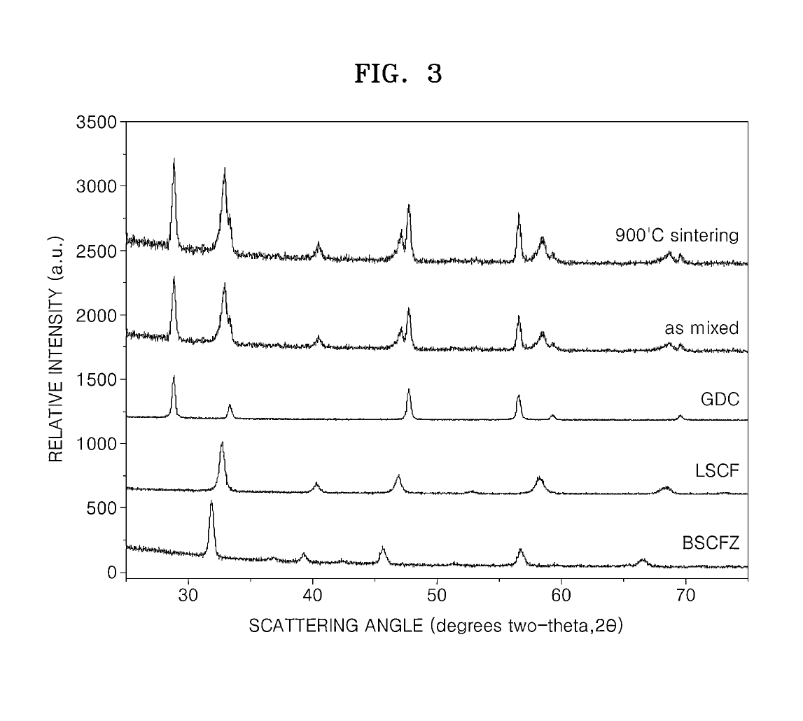

To investigate whether the perovskite materials (i.e., the first and second metal oxides) and the fluorite material (i.e., the third metal oxide) reacted with each other, after being thermally treated at 900° C., each cathode material of Preparation Example 1 was analyzed by X-ray diffraction pattern using CuKα rays. The results are shown in FIG. 3. For comparison with the X-ray diffraction patterns of the cathode material of Preparation Example 1, X-ray patterns of BSCF, LSCF used in Preparation Example 1, and GDC and X-ray patterns before and after firing after mixing are also shown in FIG. 3.

As shown in FIG. 3, it was confirmed that phases of BSCFZ, LSCF, and GDC were maintained after a complex material of BSCFZ, LSCF, and GDC was fired at a temperature of 900° C. From this result, it was confirmed that a secondary phase was not formed during sintering and the material was physically mixed. When a composite is formed using two or more materials, if a secondary phase is formed during sintering, advantages of the used materials can be offset. Offsetting does not occur in this material.

### Examples 1-3

### Preparation of Cell

A test cell in which a pair of functional layers and a pair of cathode layers are stacked with respect to an electrolyte layer was prepared as follows.

Scandia stabilized zirconia Zr_{0.8}Sc_{0.2}O_{2-ζ}, wherein ζ is a value such that the zirconium-based metal oxide represented by this formula is electrostatically neutral (ScSZ) (FCM, USA) was used as a material of an electrolyte layer. 1.5 g of the ScSZ was put in a mold having a diameter of 1 centimeter (cm), was uniaxially pressed at a pressure of about 200 megaPascals (MPa), and then was sintered at a temperature of 1550° C. for 8 hours to prepare an electrolyte layer having a pellet shape.

Gadolinium-doped ceria (GDC)(Ce_{0.9}Gd_{0.1}O_{2-η}, wherein η is a value such that the ceria-based metal oxide represented by this formula is electrostatically neutral) (FCM, USA) was used as a material for a functional layer. The GDC and an organic vehicle (ink vehicle, VEH, FCM, USA) were uniformly mixed in a weight ratio of 3:2 to prepare a slurry and then the slurry was screen-printed on two opposite surfaces of the electrolyte layer by using a 40 μm screen. Then, the screen-printed electrolyte layer was sintered at a temperature of 1400° C. for 5 hours to obtain functional layers.

The materials for a solid oxide fuel cell prepared in Preparation Examples 1-3, that is, the BSCFZ, LSCF, and the ceria-based metal oxide (GDC or SNDC) powders were mixed with an organic vehicle (ink vehicle, VEH, FCM, USA) in a weight ratio of 2:3 in a mortar to obtain a slurry for forming a cathode layer.

The slurry for forming a cathode layer was screen-printed on the pair of functional layers by using a 40 μm screen. Then, the screen-printed functional layers were dried in an oven at a temperature of 100° C., were moved to a firing furnace, and then were sintered at a temperature of 900° C. for 2 hours to obtain a cathode layer.

### Comparative Example 1

### Preparation of Comparative Cell

A comparative cell 1 was completed in the same manner as in Examples 1 to 3, except that a cathode layer was formed using the BSCFZ (Ba_{0.5}Sr_{0.5}Co_{0.8}Fe_{0.1}Zn_{0.1}O_{3-δ}) used in Examples 1-3 alone as a cathode material.

### Comparative Example 2

### Preparation of Comparative Cell

A comparative cell 2 was completed in the same manner as in Example 1, except that a cathode layer was formed using BSCFZ+LSCF (weight ratio: 1:1) as a cathode material.

### Comparative Example 3

### Preparation of Comparative Cell

A comparative cell 3 was completed in the same manner as in Example 1, except that a cathode layer was formed by using BSCFZ+GDC (weight ratio: 7:3) as a cathode material.

### Comparative Example 4

### Preparation of Comparative Cell

A comparative cell 4 was completed in the same manner as in Example 1, except that a cathode layer was formed by using BSCFZ+SNDC (weight ratio: 7:3) as a cathode material.

### Comparative Example 5

### Preparation of Comparative Cell

A comparative cell 6 was completed in the same manner as in Example 1, except that a cathode layer was formed using BSCF (Ba_{0.5}Sr_{0.5}CO_{0.8}Fe_{0.2}O_{3-δ}, wherein δ is a value such that the metal oxide represented by this formula is electrostatically neutral, and hereinafter, referred to as ‘BSCFZ’ with regard to the Examples) alone as a cathode material.

In Comparative Example 5, the BSCF powder was synthesized via an ethylenediaminetetraacetic acid (EDTA)-citric method. In detail, 3.5630 g of Ba(NO₃)₂, 2.8853 g of Sr(NO₃)₂, 6.3485 g of Co(NO₃)₃.6H₂O, 2.2031 g of Fe(NO₃)₃.9H₂O, 9.15 g of EDTA, and 6.10 g of citric acid were put in 150 mL of distilled water and then were stirred by a magnetic bar until completely dissolved. In order to remove an organic component, the solution was maintained on a hot plate at a temperature of 250° C. for 12 hours to obtain a dry powered product. The powered product was heat-treated at a temperature of 900° C. for 2 hours to obtain Ba_{0.5}Sr_{0.5}Co_{0.8}Fe_{0.2}O₃ (hereinafter, referred to as ‘BSCF’ with regard to the Examples) powder having a perovskite structure, and then the powder was used as a cathode material of a comparative cell 5.

### Comparative Example 6

### Preparation of Comparative Cell

The comparative cell 5 was completed in the same manner as that in Example 1, except that a cathode layer was formed using La_{0.8}Sr_{0.4}Co_{0.2}Fe_{0.8}O₃ (“LSCF”, FCM, USA) alone as a cathode material.

### Evaluation Example 3

### Cross-Sectional Scanning Electron Microscopy

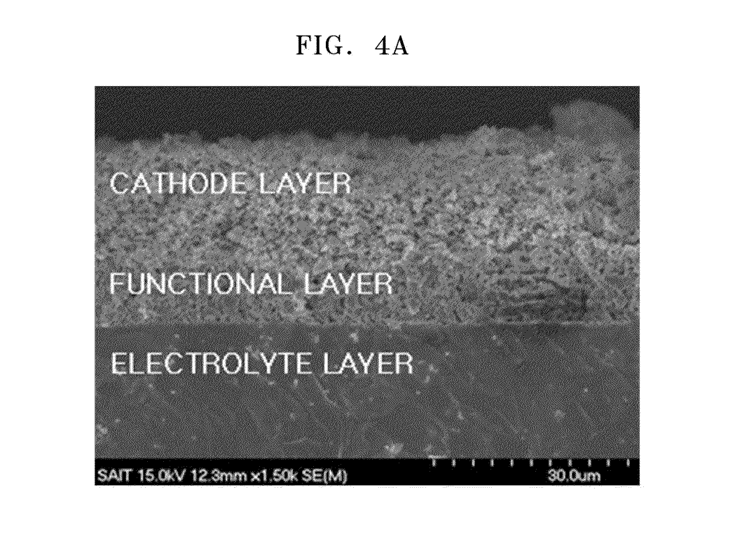

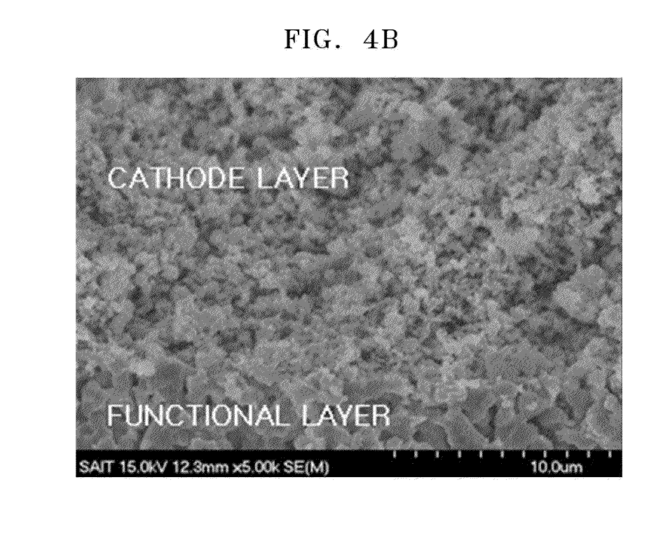

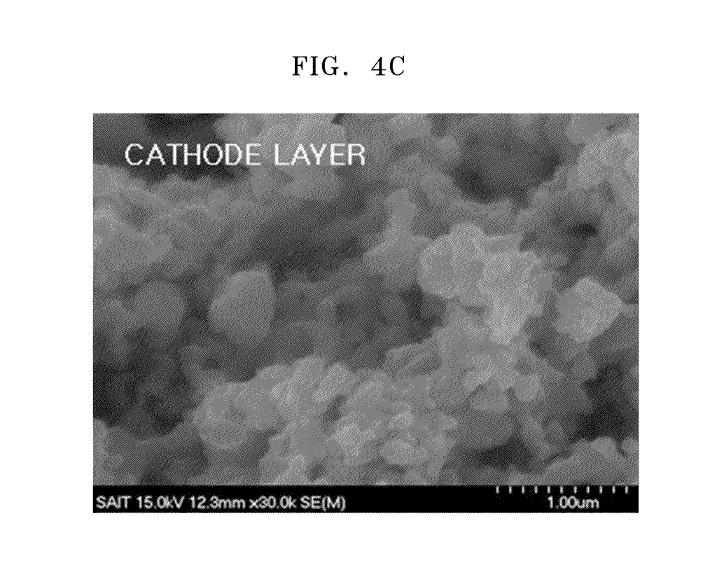

An SEM image of a half cell of the test cell prepared in Example 1 was measured and the results thereof are shown in FIGS. 4A through 4C. Shown in FIG. 4A is the electrolyte layer and the functional layer between the electrolyte layer and the cathode layer. FIG. 4B is an enlarged SEM image showing adhesion between the functional layer and the cathode layer. FIG. 4C is an enlarged view of the SEM image of the cathode layer.

While not wanting to be bound by theory, it is understood that a dense GDC functional layer that is between an electrolyte material and a cathode material having a relatively high thermal expansion coefficient, may prevent a chemically undesirable reaction therebetween, and may also reduce mechanical tension between the layers. The functional layer is understood to prevent an element, such as Sr, from diffusing and forming a byproduct, such as SrZrO₃, by spatially separating the cathode and electrolyte layers. From a difference in a particle size shown in FIGS. 4A through 4C, it may be confirmed that the cathode layer has a structure in which relatively large (e.g., about 0.5 μm) and small (e.g., about 0.1 μm) particles are both present.

### Evaluation Example 4

### Impedance Analysis

(1) Measurement of Resistance According to Cathode Composition

Impedance of each of the test cells manufactured according to Examples 1 and 2 was measured in an air atmosphere, and results thereof are shown in Table 2. Impedance was measured using a Materials Mates 7260 instrument, manufactured by Materials Mates Co., Ltd. Also, an operating temperature of each of the test cells was maintained at 600° C. or 700° C. during the analysis.

TABLE 2

| | | Resistance | Resistance |
|---|---|---|---|
| | Composition of Cathode | (ohm · cm²) at | (ohm · cm²) at |
| | Material | 600° C. | 700° C. |
| Example 1 | BSCFZ + LSCF + GDC | 0.04 | 0.012 |
| | (3.5:3.5:3) | | |
| Example 2 | BSCFZ + LSCF + GDC | 0.19 | 0.04 |
| | (4:4:2) | | |

In general, an amount of a ceria-based compound in a composite is determined to be less than about 30 wt % of the composite. However, as shown in Table 2 above, the resistance measurement results of Examples 1 and 2 using a ternary cathode material of BSCFZ+LSCF+GDC show that an excellent resistance of about 0.04 Ωcm² at a temperature of 600° C. is obtained even when 30 wt % of gadolinia-doped ceria (“GDC”) is contained.

(2) Measurement of Resistance According to Cathode Composition

Impedances of the test cells prepared in Examples 1 and 3 and Comparative Examples 1-4 were measured in an air environment using a Materials Mates 7260 available from Materials Mates, and the results thereof are shown in Table 3. An operating temperature of the test cell was 650° C. or 700° C.

TABLE 3

| | | Resistance | Resistance |
|---|---|---|---|
| | Composition of Cathode | (ohm · cm²) at | (ohm · cm²) at |
| | Material | 600° C. | 700° C. |
| Example 1 | BSCFZ + LSCF + GDC | 0.04 | 0.012 |
| | (3.5:3.5:3) | | |
| Example 3 | BSCFZ + LSCF + | 0.055 | 0.02 |
| | SNDC (3.5:3.5:3) | | |
| Comparative | BSCFZ alone | 0.16 | 0.05 |
| Example 1 | | | |
| Comparative | BSCFZ + LSCF | 0.125 | 0.035 |
| Example 2 | (5:5) | | |
| Comparative | BSCFZ + GDC | 0.08 | 0.015 |
| Example 3 | (7:3) | | |
| Comparative | BSCFZ + SNDC | 0.075 | 0.04 |
| Example 4 | (7:3) | | |

As shown in Table 3 above, from the resistance measurement results of Examples 1 and 3 using a ternary cathode material of BSCFZ+LSCF+GDC or SNDC, a relatively low resistance is obtained compared to a case where BSCFZ is used alone, or compared to Comparative Examples 1-4 using a perovskite different from BSCFZ or a binary cathode material such as BSCFZ and ceria.

### Evaluation Example 5

### Measurement of Durability

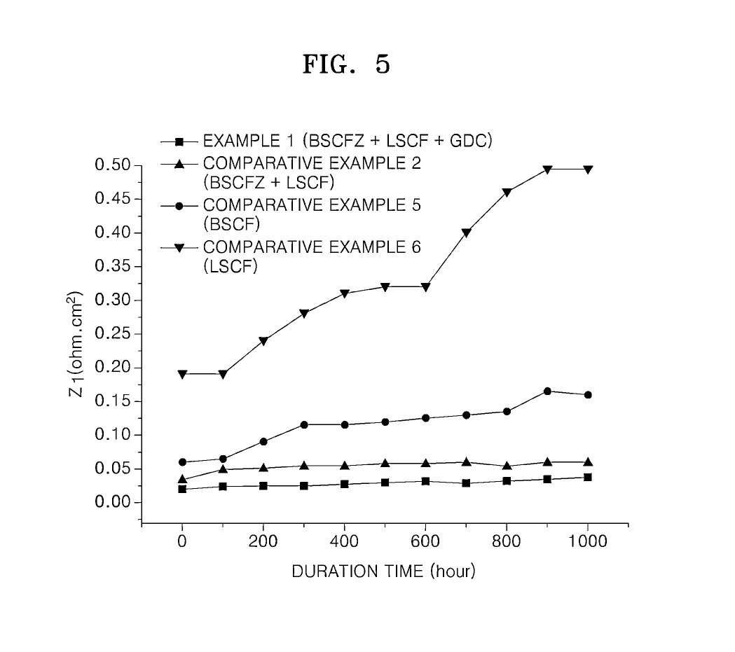

To evaluate the durability of Example 1 and Comparative Examples 1, 5, and 6, each cathode material powder was used in a symmetrical cell and was sintered at a temperature of 900° C. for 2 hours. Then, while an operating temperature of 700° C. was maintained, a resistance change was observed and the results thereof are shown in FIG. 5 and Table 4.

TABLE 4

| Duration time (hr) | | | | | | | | | | |
|---|---|---|---|---|---|---|---|---|---|---|
| @700° C. | 1 | 100 | 200 | 300 | 500 | 600 | 700 | 800 | 900 | 1000 |
| Example 1 | 0.027 | 0.025 | 0.025 | 0.03 | 0.032 | 0.03 | 0.032 | 0.035 | 0.035 | 0.035 |
| (BSCFZ + LSCF + GDC) | | | | | | | | | | |
| Comparative Example 2 | 0.045 | 0.034 | 0.055 | 0.058 | 0.058 | 0.06 | 0.055 | 0.06 | 0.06 | 0.06 |
| (BSCFZ + LSCF) | | | | | | | | | | |
| Comparative Example 5 | 0.065 | 0.09 | 0.115 | 0.12 | 0.125 | 0.13 | 0.135 | 0.165 | 0.16 | 0.162 |
| (BSCF) | | | | | | | | | | |
| Comparative Example 6 | 0.19 | 0.24 | 0.28 | 0.32 | 0.32 | 0.40 | 0.46 | 0.495 | 0.49 | 0.50 |
| (LSCF) | | | | | | | | | | |

As shown in Table 4 and FIG. 5, an increased ionic resistance and an excellent durability are obtained in Example 1 using a complex material of BSCFZ+LSCF+GDC, as compared to a case where BSCFZ is used alone, where a complex of BSCFZ and LSCF is used, or where BSCF or LSCF is used alone.

As described above, according to the an embodiment, a material for a solid oxide fuel cell increases interlayer adhesion and provides reduced resistance, and thus may be used to manufacture an improved solid oxide fuel cell that is capable of operating at a relatively low temperature, e.g., 800° C. or less.

It should be understood that the exemplary embodiments described therein shall be considered in a descriptive sense only and not for purposes of limitation. Descriptions of features, advantages or aspects within each embodiment shall be considered as available for other similar features, advantages or aspects in other embodiments.

What is claimed is:

1. A material for a solid oxide fuel cell, the material comprising:
a first metal oxide represented by Formula 1 and having a perovskite crystal structure;
a second metal oxide having
an electronic conductivity which is greater than an electrical conductivity of the first metal oxide,
a thermal expansion coefficient which is less than a thermal expansion coefficient of the first metal oxide, and
having a perovskite crystal structure; and
a third metal oxide having a fluorite crystal structure:
BaₐSr_{b}CoₓFe_{y}Z_{1-x-y}O_{3-δ}, Formula 1
wherein Z is at least one element selected from an element of Groups 3 to 12 and a lanthanide element,
a and b satisfy 0.4≦a≦0.6, 0.4≦b≦0.6, and a+b≦1,
x and y satisfy 0.6≦x≦0.9, 0.1≦y≦0.4, and x+y<1, and
δ is selected such that the first metal oxide is electrostatically neutral.

2. The material of claim 1, wherein, in Formula 1, the element of Groups 3 to 12 is at least one selected from manganese (Mn), zinc (Zn), nickel (Ni), titanium (Ti), niobium (Nb), and copper (Cu), and the lanthanide element is at least one selected from holmium (Ho), ytterbium (Yb), erbium (Er), and thulium (Tm).

3. The material of claim 1, wherein, in Formula 1, x and y satisfy 0.7≦x+y≦0.95.

4. The material of claim 1, wherein the first metal oxide has an ionic conductivity of about 0.01 to about 0.03 Siemens per centimeter at a temperature of about 500 to about 900° C.

5. The material of claim 1, wherein the second metal oxide has an electronic conductivity of about 100 to about 1000 Siemens per centimeter and a thermal expansion coefficient of about 11×10⁻⁶ to about 17×10⁻⁶ Kelvin⁻¹ at a temperature of about 500 to about 900° C.

6. The material of claim 1, wherein the second metal oxide is represented by Formula 2:
A′_{1-x′}A″_{x′}QO_{3-γ}, Formula 2
wherein A′ is at least one element selected from lanthanum (La), samarium (Sm), and praseodymium (Pr),
A″ is at least one element selected from strontium (Sr), calcium (Ca), and barium (Ba) and is different from A′,
Q is at least one selected from manganese (Mn), iron (Fe), cobalt (Co), nickel (Ni), copper (Cu), titanium (Ti), niobium (Nb), chromium (Cr), and scandium (Sc),
0≦x′<1, and
γ is selected such that the second metal oxide electrostatically neutral.

7. The material of claim 1, wherein the second metal oxide is represented by at least one of Formula 3 to Formula 7:
La_{c}Sr_{d}Q′_{w}Q″_{z}O_{3-γ}, Formula 3
wherein Q′ is at least one selected from cobalt (Co) and chromium (Cr),
Q″ is at least one selected from iron (Fe) and manganese (Mn),
c and d satisfy 0.5≦c≦0.7, 0.3≦d≦0.5, and c+d≦1,
w and z satisfy 0.1≦w≦0.9, 0.1≦z≦0.9, and w+z≦1, and
γ is selected such that the second metal oxide electrostatically neutral,
Pr_{c′}Sr_{d′}Co_{w′}Fe_{z′}O_{3-γ}, Formula 4
wherein c′ and d′ satisfy 0.4≦c′≦0.8, 0.2≦d′≦0.6, and c′+d′≦1,
w′ and z′ satisfy 0.2≦w′≦0.8, 0.2≦d′≦0.8, and w′+z′≦1, and
γ is selected such that the second metal oxide electrostatically neutral,
LaₑSr_{f}Q″O_{3-γ}, Formula 5
wherein Q″ is at least one selected from iron (Fe) and manganese (Mn),
e and f satisfy 0.4≦e≦0.8, 0.2≦f≦0.6, and e+f≦1, and
γ is selected such that the second metal oxide electrostatically neutral,
Pre′Srf′Q″O3−γ, Formula 6
wherein Q″ is at least one selected from Fe and Mn,
e′ and f′ satisfy that 0.4≦e′≦0.8, 0.2≦f′≦0.6, and e′+f′≦1, and
γ is selected such that the second metal oxide electrostatically neutral, and
Sm₁₋ᵣSrᵣQ″O_{3-γ}, Formula 7
wherein Q″ is at least one selected from Fe, Mn, and Co,
r satisfies 0.1≦r≦0.5, and
γ is selected such that the second metal oxide electrostatically neutral.

8. The material of claim 1, wherein a weight ratio between the first metal oxide and the second metal oxide is about 90:10 to about 30:70.

9. The material of claim 1, wherein the third metal oxide is a ceria metal oxide comprising at least one lanthanide element other than cerium.

10. The material of claim 9, wherein the third metal oxide is a ceria metal oxide represented by Formula 8:
Ce_{1-q}M′_{q}O₂, Formula 8
wherein M′ is at least one selected from lanthanum (La), praseodymium (Pr), neodymium (Nd), promethium (Pm), samarium (Sm), europium (Eu), gadolinium (Gd), terbium (Tb), dysprosium (Dy), and an alloy thereof, and 0<q<1.

11. The material of claim 1, wherein the third metal oxide is a ceria metal oxide comprising at least two lanthanide elements other than cerium, and
wherein an average ionic diameter of the at least two lanthanide elements other than cerium is about 0.90 to about 1.06.

12. The material of claim 11, wherein the at least two elements other than cerium are selected from Sm, Pr, Nd, Pm, and an alloy thereof.

13. The material of claim 11, wherein the ceria metal oxide is represented by Formula 9:
Ce_{1-q′-q″}Sm_{q′}M″_{q″}O₃, Formula 9
wherein M″ is at least one selected from Pr, Nd, Pm, and an alloy thereof, and
0<q′≦0.20, 0<q″≦0.20, and 0<q′+q″≦0.3.

14. The material of claim 13, wherein, in Formula 9 above, q″ has a value equal to or less than q′/2.

15. The material of claim 1, wherein a weight ratio between a sum of the first metal oxide and the second metal oxide to the third metal oxide is about 99:1 to about 60:40.

16. A cathode for a solid oxide fuel cell, the cathode comprising the material of claim 1.

17. A solid oxide fuel cell comprising:
a cathode for a solid oxide fuel cell comprising the material of claim 1;
an anode disposed to face the cathode; and
a solid oxide electrolyte disposed between the cathode and the anode.

18. The solid oxide fuel cell of claim 17, wherein the solid oxide electrolyte comprises at least one selected from a zirconia solid electrolyte, a ceria solid electrolyte, and a lanthanum gallate solid electrolyte.

19. The solid oxide fuel cell of claim 17, further comprising an electric current collector disposed on the cathode,
wherein the electric current collector comprises at least one selected from lanthanum cobalt oxide, lanthanum strontium cobalt oxide, lanthanum strontium cobalt iron oxide, lanthanum strontium manganese oxide, and lanthanum strontium iron oxide.

20. The solid oxide fuel cell of claim 17, further comprising a functional layer that is disposed between the cathode and the solid oxide electrolyte and is effective to prevent a reaction therebetween,
wherein the functional layer comprises at least one selected from gadolinia-doped ceria, samaria-doped ceria, and yttria-doped ceria.
